(19) United States
(12) Patent Application Publication
(10) Pub. No.: US 2014/0006038 A1
(43) Pub. Date: Jan. 2, 2014

(54) Account Tracking System for Health Resource Encounters

(71) Applicants: JERAMIE HARRIS, Alexandria, MN (US); TROY RONNING, Sauk Centre, MN (US); MATT MAGNUSON, Garfield, MN (US); JIM PRZYBILLA, Brandon, MN (US)

(72) Inventors: JERAMIE HARRIS, Alexandria, MN (US); TROY RONNING, Sauk Centre, MN (US); MATT MAGNUSON, Garfield, MN (US); JIM PRZYBILLA, Brandon, MN (US)

(73) Assignee: PRIME WEST HEALTH, Alexandria, MN (US)

(21) Appl. No.: 13/534,198

(22) Filed: Jun. 27, 2012

(51) Int. Cl. G06Q 50/22

(52) U.S. Cl. 705/2

(57) ABSTRACT

Systems and methods for tracking accounts associated with health resource encounters are disclosed. In one aspect, a system for tracking accounts associated with health resource encounters is disclosed. The system includes a plurality of portable identification devices, such as smart cards, each associated with a user and a benefit account, and configured to store identification data of a user with whom the portable identification device is associated, insurance benefit information, and medical records of the user. Devices each affiliated with a health resource provider are configured to interact with a health resource encounter tracking server, which is configured to access a healthcare information database including data affiliated with a plurality of users, a plurality of benefit providers, and a plurality of heath resource providers. The health resource providers include medical providers and pharmacy providers.

### TECHNICAL FIELD

The present application relates generally to health records management systems, and in particular to an account tracking system for health resource encounters.

### BACKGROUND

Health resource encounters relate to circumstances in which an individual, being a prospective user of health resources enter into a transaction with a healthcare provider (e.g., a medical facility or pharmacy). These encounters can include encounters with medical providers, and can also include encounters with other entities relating to healthcare delivery and with whom costs may be incurred. For example, medical care providers (e.g., hospitals and clinics) traditionally deliver medical services to a patient. During a visit to a medical care provider, a patient may be requested to provide information regarding his/her medical history, including allergy information, medical treatment history, or other known medical conditions. This typically takes the form of a medical questionnaire that is completed by the patient at the time that patient arrives at the medical facility. Medical care providers may also require access to a user's insurance information to coordinate payment for particular medical services that are provided. In contrast, a health resource encounter that may occur in a different context, such as at a pharmacy, may traditionally not require access to a patient's medical history, but may still require access to a user's insurance information so that a prescription is fulfilled correctly, and to ensure that the patient is charged an appropriate amount of money to fulfill that subscription.

In both types of transactions, different subsets of a user's medical history (e.g., allergies or other sensitivities) may be useful when providing care or advising the user with information regarding administration of a prescribed medication. And, in both circumstances, many systems still rely on a patient self-reporting medical history information.

A variety of solutions have been proposed and implemented in which user records are tracked, or in which insurance coverages for those patients are managed, in either medical or pharmacy contexts. One solution involves use of a smart card for managing medical information. Such cards present a number of advantages. Typically, use of smart cards provides greater efficiency in accessing a user's health history in the event the user is incapacitated, and otherwise reduces healthcare delivery error rates. Additionally, use of smart cards can provide cost savings from avoiding sending physical medical documents between a user and his/her caregivers.

One such example solution using a smart card arrangement is discussed in U.S. Pat. No. 5,995,965. That reference discusses a smart card arrangement including example hardware that can be used, and discussing storage of user, health care, and insurance information for rapid access. However, that reference is silent as to methods of use at a health resource provider, or regarding centralized access control and/or storage of data at a location other than on the smart card.

A further example solution using a smart card arrangement is discussed in U.S. Patent Pub. No. 2003/0037065. That reference discusses use of a smart card encoded with patient and insurer information that can be used by a medical provider to access a listing of medications covered by the patient's insurance, the patient's pharmaceutical history, potential interactions/adverse effects of different drugs, whether a medication covered by the patient's health care plan may be substituted for the one the physician plans to prescribe, and/or to electronically submit a pharmaceutical prescription. An additional example solution using a smart card arrangement is discussed in U.S. Patent Pub. No. 2009/0150292. That reference discusses storage of medical data (e.g., lab reports and prescriptions) as well as insurance information on a smart card.

However, in generally these systems have drawbacks. Often, such systems only manage to integrate limited portions of the entire universe of possible health resource encounters a patient may have, and only a subset of the data describing a user's healthcare. For example, often it is the case that patient medical records and insurance coverage are maintained separately, and involve separate solutions for management and access of patient information. Due to privacy/sensitivity concerns, such systems have traditionally maintained separately from details regarding a patient's medical treatment, including allergies, medical conditions, prescription history, medical procedure history, or other data describing the specific interaction between the user and healthcare provider. Additionally, beyond typical separate storage of medical record and insurance data, existing systems traditionally track specific types of medical encounters “after the fact”, in that the medical encounter is stored only to the extent that its outcome changes a patient's medical treatment, in the form of a new prescription, treatment, or other medical event. This not only results in problems regarding lack of integration of data, but also results in limitations on the functionality of such smart card designs. For example, in such systems, it is not common, or even available, for a patient's eligibility for a particular program or treatment to be evaluated in realtime, due to lack of data integration. Furthermore, additional drawbacks exist regarding available claims pricing and submission procedure/standards exist as well, particularly when a patient may be eligible for two or more benefit programs.

In addition to the above, it is noted that specific types of information on a smart card may be limited based on the information available to the issuing entity. For example, if the smart card is issued by an insurer, the card may include insurance data alongside data of a customer/patient of that insurer, and may (but would not be required to) store health record information. If a user of such a card would switch insurers, such a smart card would then become useless, since the information stored on the card would largely be seen as proprietary to or only useful to that insurer and its network of caregivers. Similarly, if the smart card is issued by a particular medical facility or governmental program, only those entities' data would generally be stored on the smart card alongside the user's personal information. As such, existing systems have limited flexibility for use with multiple types of health resources and benefit programs/plans. Furthermore, existing systems lack security features useable to prevent unauthorized access to health services (e.g., prescription drugs or other services) in the event of a stolen benefit card or smart card. Other drawbacks are inherent in existing smart card systems as well.

For these and other reasons, improvements are desirable.

### SUMMARY

In accordance with the following disclosure, the above and other issues are addressed by the following:

In a first aspect, a system for tracking accounts associated with health resource encounters is disclosed. The system includes a plurality of portable identification devices each associated with a user and a benefit account, the user comprising a healthcare consumer and the benefit account defining coverage available to the user. Each of the plurality of portable identification devices includes a memory configured to store identification data of a user with whom the portable identification device is associated. The system also includes a plurality of computing devices each affiliated with a health resource provider at which a health resource encounter takes place. Each of the plurality of computing devices is configured to, prior to each health resource encounter between a user and the health resource provider, receive information from a portable identification device associated with the user from among the plurality of portable identification devices. Each of the plurality of computing devices is also configured to receive validation information from the user, and transmit the validation information to a heath resource encounter tracking server. Each of the plurality of computing devices is further configured to receive authorization information and benefit information associated with the user from the health resource encounter tracking server, record a log of the health resource encounter, and transmit the log of the health resource encounter to the heath resource encounter tracking server. The system also includes a health resource encounter tracking server remotely connected to each of the plurality of computing devices via a network. The health resource encounter tracking server is configured to access a healthcare information database including data affiliated with a plurality of users, a plurality of benefit providers, and a plurality of heath resource providers. The health resource providers include at least medical providers and pharmacy providers.

In a second aspect, a method of managing healthcare users affiliated with a plurality of different, unaffiliated healthcare resource providers is disclosed. The method includes, prior to a health resource encounter between a user and a health resource provider, receiving, at a heath resource encounter tracking server, information from a computing device affiliated with the health resource provider. The information includes data stored on a portable identification device associated with a user, validation information entered by the user, and an identity of the health resource provider. The method further includes, based on the data stored on the portable identification device, the validation information, and the identity of the health resource provider, determining a set of benefit information based on data stored in a healthcare information database. The healthcare information database includes data affiliated with a plurality of users, a plurality of benefit providers, and a plurality of heath resource providers. The health resource providers include at least medical providers and pharmacy providers. The method further includes receiving, at the heath resource encounter tracking server, a log of the health resource encounter, and storing the log of the health resource encounter in the healthcare information database.

In a third aspect, a system for tracking accounts associated with health resource encounters is disclosed. The system includes a plurality of smart cards, each of the smart cards associated with a user and a benefit account defining coverage available to the user. Each of smart cards includes a programmable circuit and a memory configured to store identification data of a user with whom the portable identification device is associated. The system also includes a plurality of computing devices each affiliated with a health resource provider at which a health resource encounter takes place. Each of the plurality of computing devices is configured to, prior to each health resource encounter between a user and the health resource provider, read information from a smart card associated with the user from among the plurality of smart cards. Each of the plurality of computing devices is also configured to receive validation information from the smart card, transmit the validation information and information from the smart card to a heath resource encounter tracking server, and receive authorization information and benefit information associated with the user from the health resource encounter tracking server. Each of the plurality of computing devices is further configured to record a log of the health resource encounter, and transmit the log of the health resource encounter to the heath resource encounter tracking server. The system additionally includes a health resource encounter tracking server remotely connected to each of the plurality of computing devices via a network. The health resource encounter tracking server is configured to access a healthcare information database including data affiliated with a plurality of users, a plurality of benefit providers, and a plurality of health resource providers, the health resource providers including at least medical providers and pharmacy providers. The health resource encounter tracking server is further configured to generate one or more reports in response to requests from remote computing systems, and exchange healthcare information regarding one or more of the plurality of users with a third party system, the healthcare information including the one or more reports.

### BRIEF DESCRIPTION OF THE DRAWINGS

FIG. 1 is a schematic view of an account tracking system for health resource encounters, according to an example embodiment of the present disclosure;

FIG. 2 is a schematic view of example health resource encounters which may take place within the account tracking system of FIG. 1;

FIG. 3 is a schematic view of a healthcare database useable within the account tracking system of FIG. 1;

FIG. 4 is a schematic view of an example smart card useable within the account tracking system of the present disclosure;

FIG. 5 is a flowchart of methods and systems for use of an account tracking system at a location where a health resource encounter may take place, according to an example embodiment of the present disclosure;

FIG. 6 is a flowchart of methods and systems for operation of an account tracking system, according to an example embodiment of the present disclosure;

FIG. 7 is a flowchart of a method of validating a user and providing a user interface for interaction with an online portal of the account tracking system, according to an example embodiment of the present disclosure;

FIG. 8 is a flowchart of a method of validating a user and providing a user interface for interaction with an online portal of the account tracking system, according to a further example embodiment of the present disclosure; and

FIG. 9 illustrates an electronic computing device with which aspects of the account tracking system for health resource encounters can be implemented.

### DETAILED DESCRIPTION

Various embodiments of the present invention will be described in detail with reference to the drawings, wherein like reference numerals represent like parts and assemblies throughout the several views. Reference to various embodiments does not limit the scope of the invention, which is limited only by the scope of the claims attached hereto. Additionally, any examples set forth in this specification are not intended to be limiting and merely set forth some of the many possible embodiments for the claimed invention.

The logical operations of the various embodiments of the disclosure described herein are implemented as: (1) a sequence of computer implemented steps, operations, or procedures running on a programmable circuit within a computer, and/or (2) a sequence of computer implemented steps, operations, or procedures running on a programmable circuit within a directory system, database, or compiler.

In general the present disclosure relates to methods and systems for account tracking relating to health resource encounters. Generally, health resource encounters correspond to transactions during which a health product is provided. Example health resource encounters can include, for example, hospital and/or clinic visits, pharmacy visits, or other visits to entities that may have health-related goods or services for which costs may at least partially be apportioned to a health benefit plan or benefit account, such as a health insurance plan, health savings account or health reimbursement account, or other analogous arrangement. In some embodiments, the present disclosure relates to a smart card and associated health resource encounter tracking server useable to provide one or more user interfaces to a health service provider for clearing and reporting various types of access, including access attempts, as well as prescribed medications, treatments, or other types of goods/services that may be provided in such an encounter.

It is recognized that, using the methods and systems described herein, users, health service providers, and health benefit providers are provided with a number of advantages. For example, using the methods and systems of the present application, one or more medical treatments can be approved at a central system, either based on a list of preapproved treatments or based on benefit plan and cost information managed centrally for a particular user. Additionally, the smart card and other systems of the present disclosure provide for improved flexibility in allowing a variety of types of data to be associated with a smart card, such as multiple, different health resource providers or benefit providers, either through storage on a smart card or in a central database. Other advantages are provided via the present disclosure as well, and are apparent in view of the below disclosure.

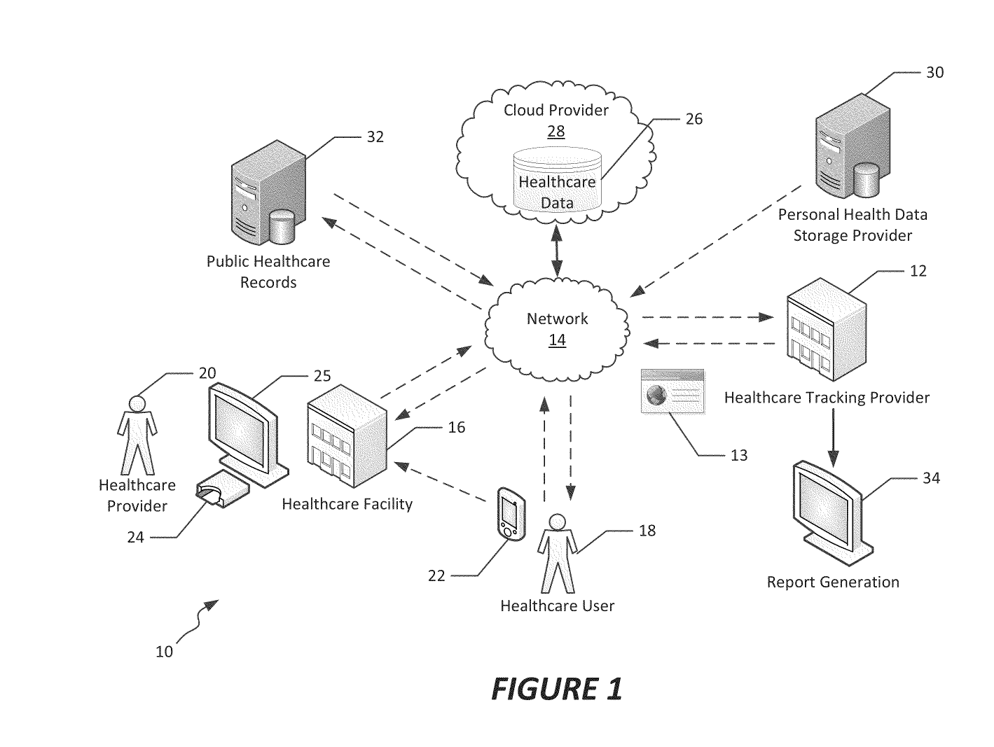

Referring now to FIG. 1, a schematic view of an account tracking system 10 is illustrated for use in connection with health resource encounters, according to an example embodiment. The account tracking system 10 includes a health resource encounter tracking server 12 communicatively connected to a network 14, and which is generally accessible from a variety of health resource providers, such as healthcare facility 16.

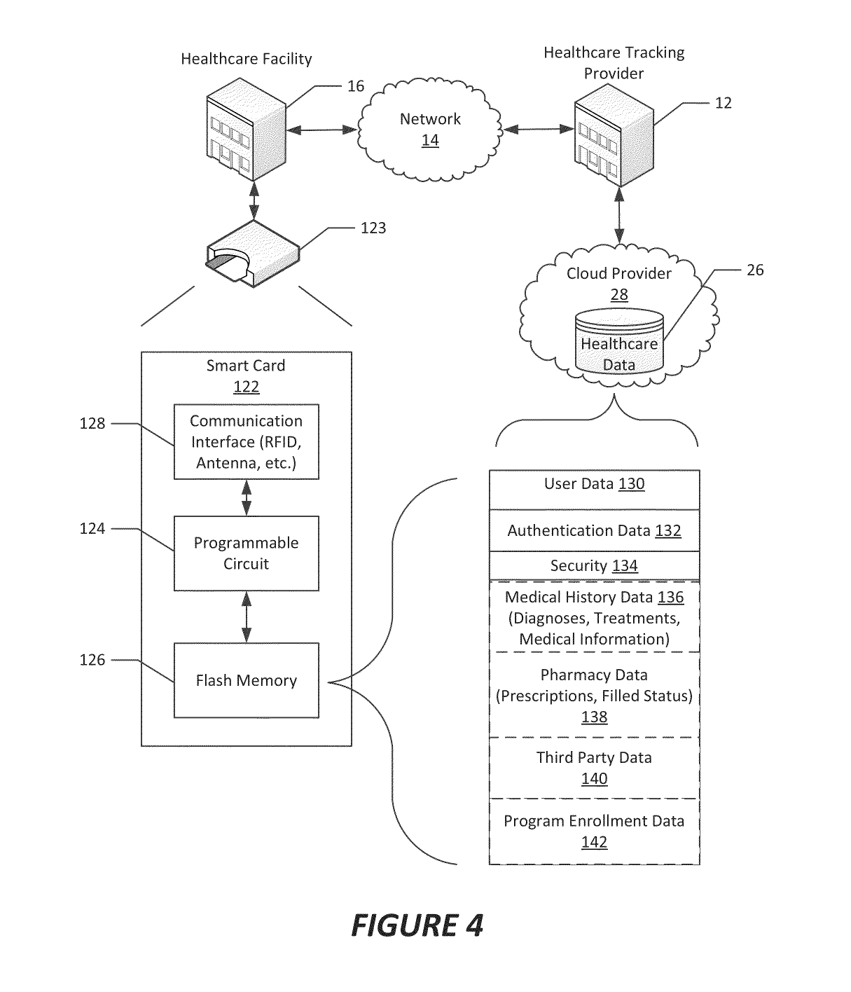

The health resource encounter tracking server 12 generally is configured to be accessible to one or more remote systems, in particular systems located at one or more different types of healthcare facilities 16, such as a medical facility or pharmacy facility. As discussed in further detail below, the health resource encounter tracking server 12 generally acts to authenticate users, such as a user 18, who visits a healthcare facility and presents a portable identification device 22 to a healthcare provider 20 at the facility 16. In some embodiments discussed herein the portable identification device 22 can be a smart card, discussed in further detail in connection with FIG. 4. The server 12 can receive an identifier of the smart card, as well as validation data entered by the user 18, to validate that the user has the correct card, and is in fact the user to be associated with the card and who is a member in one or more benefit plans. For example, the healthcare provider 20 can communicatively connect a smart card or other portable identification device with a reader 24, and upload that information to the server 12 from the healthcare facility 16. In alternative embodiments where the device 22 includes a direct communication connection capable of interconnection to a computing system, the reader 24 may be unnecessary.

Additionally, the health resource tracking server 12 provides a portal, capable of presenting one or more user interfaces to users at the healthcare facility via a display 26 (which can be associated with one or more computing systems at that facility). The portal, capable of being presented on a computing device 25 at the healthcare facility 16 or to a user on a personal device, allows users and/or entities to access medical records data based on the identity of that entity. For example, a healthcare provider can access and enter proposed treatments into the portal and receive authorization for providing such treatments to the user. The user can, in some embodiments, access a read-only version of his/her medical history, and can edit user information included in a database managed by the server 12. Third parties, such as third party benefit providers or governmental entities, can access other types of information relevant to those entities (e.g., aggregated reporting data, as mentioned below).

In some embodiments, the health resource encounter tracking server 12 is managed and associated with a particular health benefit provider. However, in alternative embodiments, in particular where various health benefit providers typically use a common set of healthcare providers, the health resource encounter tracking server 12 can manage data relating to health benefit plans of multiple such health benefit providers.

The network 14 can be any of a variety of network systems configured to provide data communication across disparate, geographically dispersed locations. For example, the network 14 can include one or more wired and/or wireless data systems, such as Ethernet, 802.x, or cellular data networks. In one example embodiment, the network 14 can at least partially comprise the Internet. Additionally, the healthcare facility 16 can be any of a variety of locations where a health resource encounter may take place. Example healthcare facilities 16 can include hospitals, clinics, pharmacies, or other locations where such an encounter may occur.

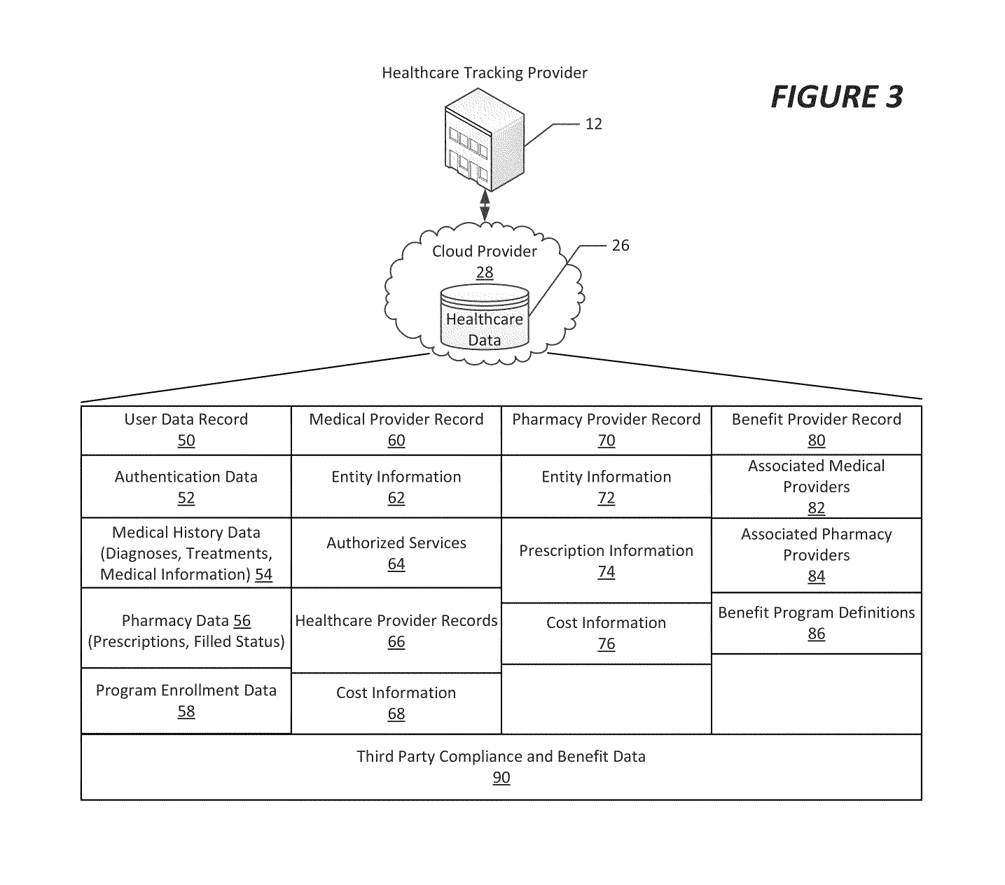

A healthcare database 26 is maintained in a manner accessible to the health resource encounter tracking server 12, and generally includes a variety of types of data associated with a user 18, one or more healthcare facilities 20, and one or more benefit plans offered by a healthcare benefit provider (e.g., an insurance provider). The healthcare database 26 can include a variety of types of information available to any of the user, healthcare provider, and benefit provider. Details regarding example data that can be included in the healthcare database 26 are provided below in conjunction with FIG. 3. In general, the healthcare database 26 is accessible to the health resource encounter tracking server 12. In the embodiment shown, the healthcare database 26 is maintained at a cloud provider 28, such that maintenance of the healthcare database 26 is obscured, but substantially continuous access to data in the database 26 is ensured. Additionally, use of a cloud provider 28 allows the entity managing the health resource encounter tracking server 12 to adjust resources as needed based on a volume of data requests received at the server 12. In some embodiments, the database 26 is managed using a cloud-based services such as Amazon Web Services, provided by Amazon.com, Inc., of Seattle, Wash. In alternative embodiments, the healthcare database 26 is maintained locally on the health resource encounter tracking server 12.

The system 10 can support communication between the health resource encounter tracking server 12 and a variety of other entities. This can be managed, for example, by reference to remote data within the healthcare database 26 that can be requested as needed, and by allowing third-party entities to have at least limited access to data in the healthcare database 26. For example, in the embodiment shown, a personal heath data storage provider 30 may store data of a user, such as healthcare records. An example health data storage provider 30 can be configured to store healthcare records in a manner that they can be accessed by the healthcare user 18, as well as integrated into the healthcare database 26 as requested by the healthcare user 18, for example by using a user-specific portion of a portal 13 available on the health resource encounter tracking server 12. Additionally, at least a portion of data in the healthcare database 26 may include data from public healthcare records 32 associated with users having an associated health benefit account and user device 22. For example, state- or federal-healthcare programs that are used in connection with a private health benefit program can share data into the server 12, to allow coordination of benefit data to ensure that correct benefits are granted to the user 18. For example, although the healthcare user 18 may be required to pay for a prescription under an enrolled benefit plan or may have a particular treatment not be approved based on that user's benefits, the user may also qualify for a state or federal program that may cover such a prescription or treatment. As such integration of this type of third party data allows a user to maximize his/her benefits, while concurrently allowing authorization of the healthcare encounter to occur through a single smart card arrangement (despite the fact that benefits are derived from two or more entities).

Referring back to the health resource encounter tracking server 12, the server 12 can be configured to generate one or more reports 34, either at the location of the server 12 or in response to a remote request, for example by a user 18 or a healthcare provider 20. For example, a user 18 may request reports regarding usage of healthcare services, or a summary of healthcare encounters within a specific date range. Alternatively, a healthcare provider 20 associated with a healthcare facility 16 may request one or more reports related with that healthcare facility, such as relating to a number and type of services provided at various healthcare encounters, a number of different users, or other types of information. In still further examples, third parties, such as governmental organizations, may be capable of requesting reports from the server 12 relating to administration of one or more third party benefit programs (e.g., governmental or private third party programs) using the server. Other types of reports could be generated as well.

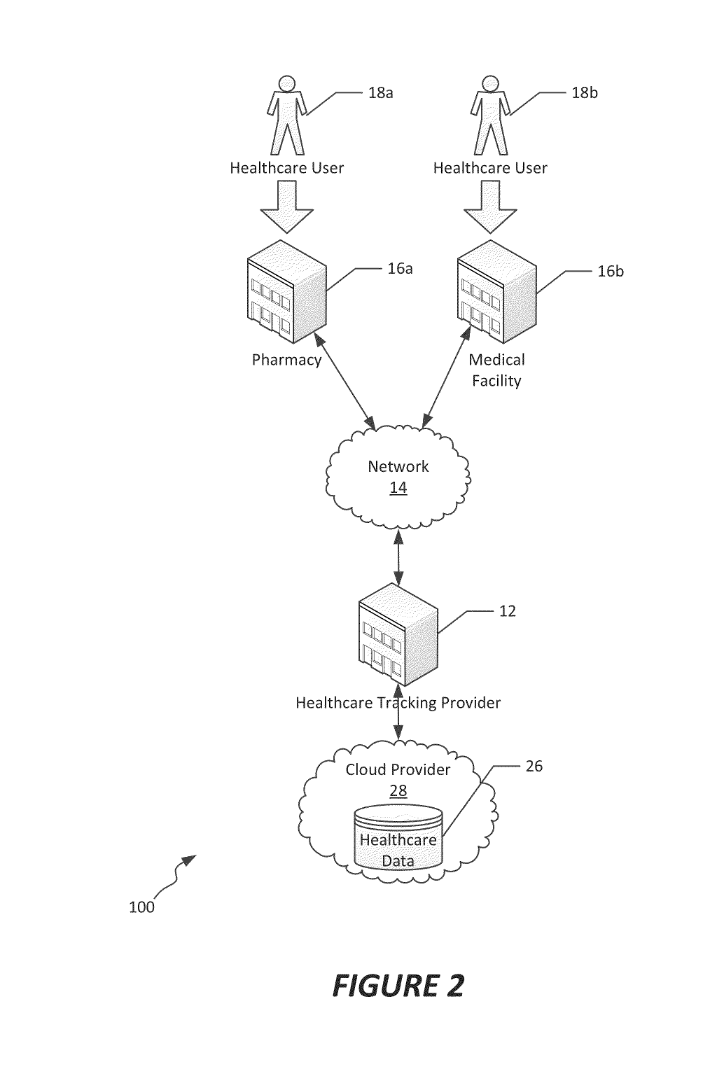

Referring now to FIG. 2, a schematic view 100 of example health resource encounters that may take place within the account tracking system 10 of FIG. 1 is depicted. The schematic, as illustrated, depicts a streamlined flow of data in the event of a healthcare encounter. In the embodiment shown, two different healthcare users 18, shown as users 18a-b, are illustrated, as visiting two different, unaffiliated healthcare providers 16, shown as a pharmacy 16a and a medical facility 16b. Although two users and two different healthcare providers are illustrated in FIG. 2, it is recognized that additional users and/or facilities are typically incorporated into an account tracking system 10, and as such, systems supporting multiple users and/or healthcare providers are encompassed within the present disclosure. In addition, other types of healthcare providers could be incorporated into such a system, such as dental providers, vision care providers, chiropractic services providers, or clinical services providers.

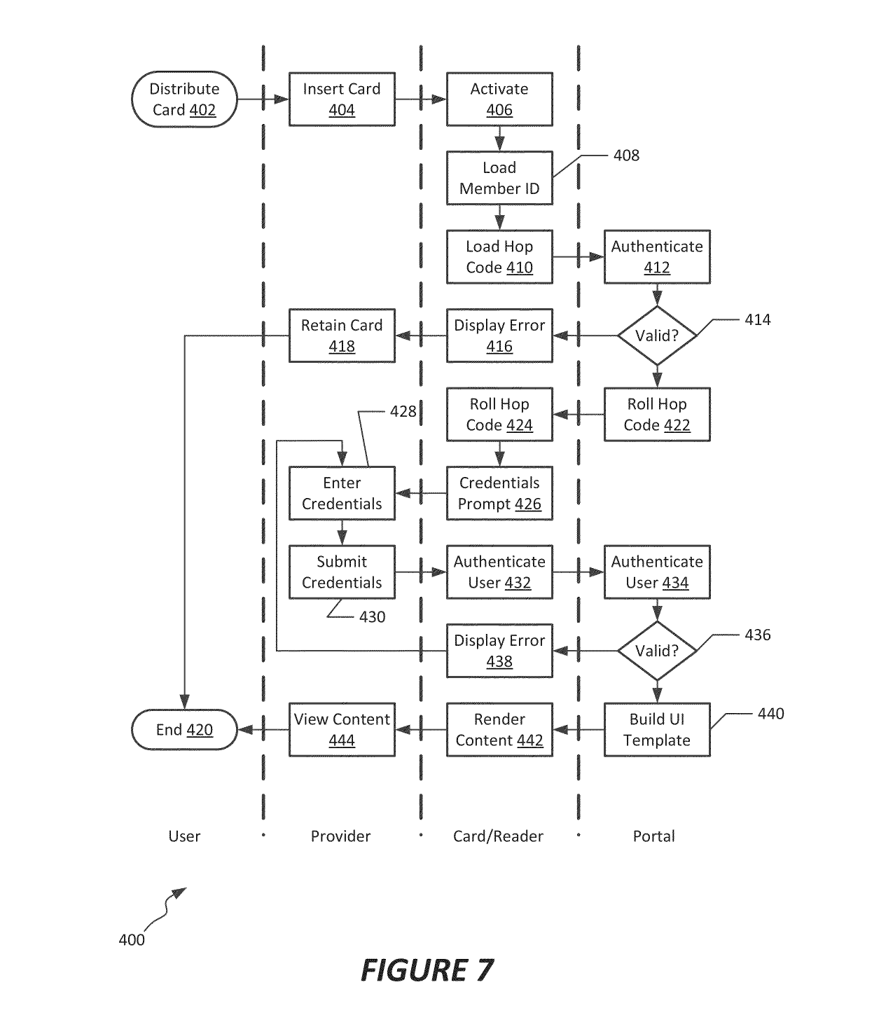

Irrespective of whether a user 18 visits a pharmacy or a medical facility, or some other healthcare provider, that user will present a user device 22, such as a smart card, to an individual at the facility 16. The user can then be required to validate his/her presence, for example using the methods discussed below in connection with FIG. 7. Generally, validation data is transmitted from each facility 16, via network 14, to the health resource encounter tracking server 12. The health resource encounter tracking server 12 then accesses the healthcare database 26 to validate the user based on that user's presence in the database, as well as benefit information associated with that user (described below). Once the user is validated, that user can then receive one or more healthcare goods/services at the healthcare encounter based on the type of encounter.

The healthcare database 26 and health resource encounter tracking server 12 can then return to the healthcare facility one or more user interfaces, such as a portal 13 into which data regarding the healthcare encounter between the facility and the user 18 can be entered, and validated against plan information either received at the facility 16, or as maintained by the health resource encounter tracking server 12 and healthcare database. The portal 13 further allows that healthcare encounter to be captured and aggregated at the database 26.

It is noted that the specific type of encounter will result in different types of data to be aggregated, and different types of information to be required from the healthcare database 26 by that facility 16. For example, a pharmacy may require user identity and authorization information, but may also require prescription information (e.g., existing and past subscriptions, a filled status of those prescriptions, or remaining refills available), allergy information, and copay or other benefit information. In contrast, a medical facility may also require identity and authorization information, but may require additional medical history information, including treatments received and timing of such treatments, additional details regarding health benefits available to the user, third party data (e.g., governmental or third party health benefit program data), preapproved treatment information regarding treatments that can be applied by the healthcare provider without receiving prerequisite authorization of a benefit provider, or other data as needed. Generally, the specific data required by a particular healthcare encounter location can be defined and made available to that entity, without disclosing all of the information associated with a particular user, to maintain a level of confidentiality regarding medical records of each user.

Referring now to FIG. 3, a schematic view of the healthcare database 26 as accessible to the health resource encounter tracking server 12 is illustrated. The schematic view depicted in FIG. 3 is intended to represent the types of data stored in the database 26, rather than any particular storage organization applied therein, which forms no part of the invention disclosed herein.

In the embodiment shown, the database 26 includes user data records 50, medical provider records 60, pharmacy records 70, and benefit records 80. However, in alternative embodiments, other types of data can be managed at the cloud provider 28. For example, although as discussed above the health resource encounter tracking server 12 provides the web portal interface accessed by healthcare providers 16, in alternative embodiments, the web portal can be hosted within the cloud provider 28 in addition to the healthcare database 26.

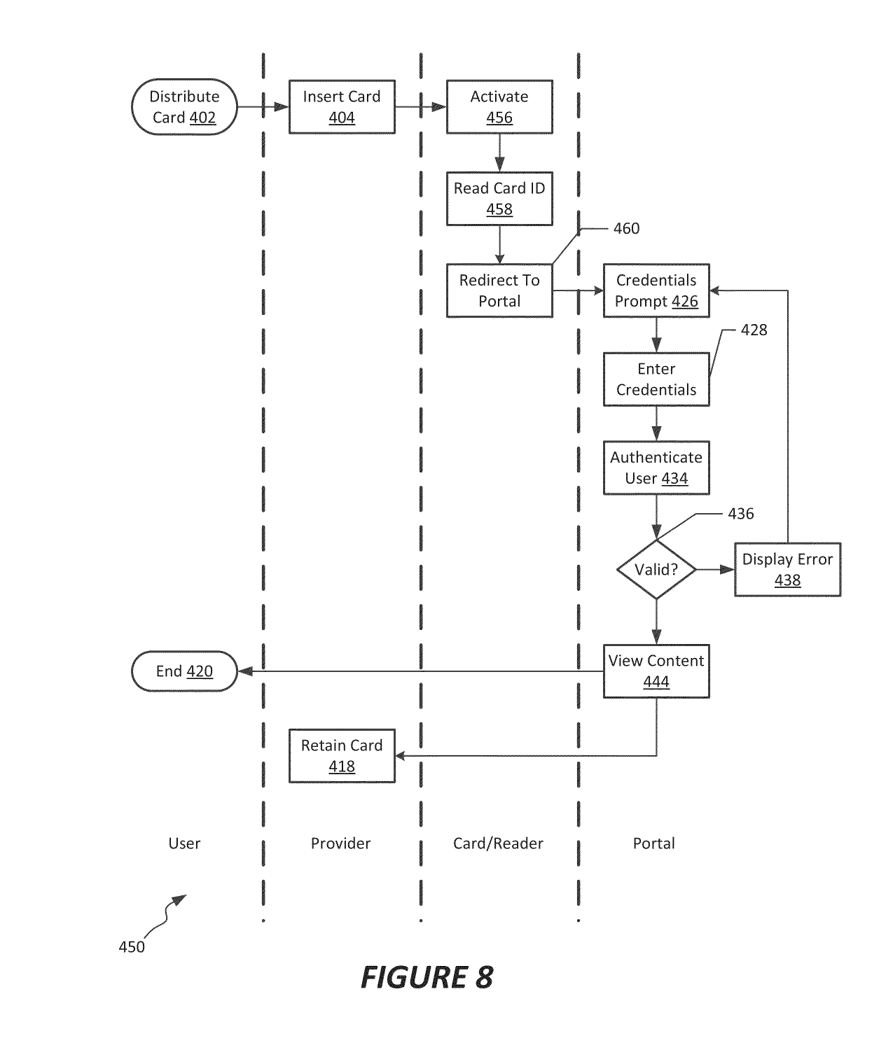

In the embodiment shown, the user data records 50 include authentication data 52, medical history data 54, pharmacy data 56, and benefit program enrollment data 58. The authentication data 52 can include personal information of the user, such as a name, address, identification number (e.g., Social Security Number or employee ID number), and other identifying information. Administrative information like electronic payments, electronic data interchange (EDI), electronic order processing, on-line data transfer can be included as well. The authentication data 52 can also store a PIN or password useable by the healthcare user to validate access at a particular healthcare provider, consistent with the methods described below in FIGS. 7-8.

The medical history data 54 can include a variety of types of medical records, such as health history information, health treatment information and treating physician information, diagnoses, or other medical information associated with the user. Additionally, medical analysis, medical images and lab reports can easily be stored as well. The pharmacy data 56 similarly stores a history of current and past prescriptions, including both filled and pending prescriptions, and the status thereof. The benefit program enrollment data 58 defines one or more programs with which the user is enrolled, as well as an identity of the particular plan in which the user is enrolled. Other user data could be incorporated into the user data records 50 as well.

In the embodiment shown, the medical provider records 60 include entity information 62, authorized service information 64, healthcare provider records 66, and cost information 68. The entity information 62 provides a definition of the entity, while the authorized service information 64 includes a definition of preauthorized treatments available at the medical provider, and treatments capable of being performed at the medical provider. The healthcare provider records 66 correspond to a record of treatments provided by the medical provider and entered into the portal provided by server 12, while cost information 68 includes both costs charged for such treatments as well as negotiated rates for various treatments as defined by negotiations between the medical provider and different health benefit providers. Other information could be incorporated into the medical provider records 60 as well, such as claim processing tools, claim price estimation tools or guidelines, or other data.

In the embodiment shown, the pharmacy records 70 include entity information 72, prescription information 74, and cost information 76. The entity information defines the pharmacy entity, while prescription information 74 maintains a record of prescriptions fulfilled by that pharmacy that have been recorded as being entered into the portal provided by the server 12. The cost information 76 records information regarding costs charged for fulfilling various subscriptions, as well as available costs to be charged for various prescription medications according to various health benefit plans, to the extent that prenegotiated rates may be negotiated by health benefit providers. Other information could be incorporated into the pharmacy records 70 as well.

In the embodiment shown, the benefit records 80 include medical providers 82, pharmacy providers 84, and benefit program definitions 86. The benefit records 80 are associated with one or more benefit providers, with each benefit provider having a listing of medical providers 82 and pharmacy providers 84 included as part of that benefit provider's “network” of approved healthcare providers. The benefit program definitions 86 include one or more benefit plans offered by each of the benefit providers, including information regarding approved services, deductible information, coverage and terms information, copay information, or other information typically defined in a health benefit plan. Other information could be incorporated into the benefit records 80 as well.

Additionally, in the embodiment shown, the database 26 includes third party compliance and benefit data 90. The third party compliance and benefit data 90 corresponds to data associated with one or more governmental programs, including a definition of facilities participating in the program, and benefits afforded by the program user eligibility for the program. The third party compliance and benefit data 90 can also include records required to be kept associated with each user and/or healthcare facility for governmental oversight purposes. Other compliance and benefit data 90 can be stored as well. Furthermore, and referring to the database 26 overall, it is recognized that other types or arrangements of data could be used as well, consistent with the concepts disclosed herein.

It is noted that, in varying embodiments of the present disclosure, additional data could be incorporated into the database 26, depending upon the type and variety of healthcare providers with whom the device 22 or smart card 122 is associated. In some example embodiments, beyond the authentication data, medical history data, pharmacy data, and program benefit data described above, additional information, such as eligibility information associated with one or more benefit programs, or rules for cost sharing and/or apportionment across one or more benefit programs, could be employed, and stored in the database 26.

Now referring to FIG. 4, a schematic view of an example arrangement is shown that useable within the account tracking system 10 of the present disclosure. In particular, the arrangement illustrated in FIG. 4 represents a portion of the account tracking system 10, depicting particular details regarding a smart card 122 issued to a particular healthcare user 18. The smart card 122 is configured to be inserted into a smart card reader 123 located at a health care provider to validate a user 18.

As illustrated, the smart card 122 represents one possible portable user identification device 22 useable within the system 10. In example embodiments, the smart card 122 is a Java 3.0-compatible card capable of storing instructions and data. However, other card formats are possible as well. In the embodiment shown, the smart card 122 includes a programmable circuit 124 communicatively connected to a memory 126 and a communication interface 128.

The programmable circuit 124 can be any of a number of different types of programmable circuits capable of being embedded in a thin card, such as an FPGA or ASIC-based programmable circuit configured to operate under low power conditions. The memory 126 can be any of a variety of types of memories useable in a low power device. In the example shown, the memory 126 includes a flash memory configured to store a variety of information associated specifically with the user to whom the smart card is issued. Additionally, the communication interface 128 provides a communicative connection to the smart card reader 123; in various embodiments, the communication interface 128 can be a wired or short-range wireless connection. In embodiments where the communication interface 128 represents a wired, or direct electrical, connection, the programmable circuit 124 and memory 126 can be powered by the smart card reader 123 via the interface 128; in wireless embodiments, the communication interface and/or programmable circuit can be embodied as a radio-frequency receiver-transmitter, analogous to commonly-used RFID-based circuitry. Other embodiments are possible as well, for example ones in which the smart card reader becomes unnecessary due to a direct connection capability (e.g., via USB interface or other wired or wireless interface) of the smart card 122 itself.

Within the memory 126 of the smart card, a variety of different types of information can be stored. In a typical usage scenario, the memory 126 can store an encrypted user identifier, illustrated as identification information 130, which can be transmitted via smart card reader 123 to the health resource encounter tracking server 12, which can decrypt that identifier and determine an identity of the user and thereby access records of that user from a database, such as the database 26 described above. In alternative embodiments, such as those in which a healthcare provider is not reliably connected to the Internet or where the health resource encounter tracking server 12 is not readily accessible, additional information can be stored in the memory 126. For example, in those cases the memory 126 can store not just identification information 130 associated with the user 18, such as the user's name, address, or other contact information. The memory 126 can also store authentication information 132 of the user, such as a username or credentials capable of validation relative to a PIN or password to be entered by the user. Preferably, to the extent that authentication information is stored in the memory, it is maintained in an encrypted format such that loss or theft of the card would not compromise the authentication information and allow an unauthorized individual to successfully use the card to obtain healthcare services (e.g., to purchase prescription drugs using another person's prescription, access/withdraw funds from a health savings account, or other type of fraudulent activities). In some embodiments, the memory 126 also stores security information 134, for example encryption information and/or encryption key information capable of accessing encrypted records on the card 122.

In addition to the above, a variety of data from the database 26 can also be selectively carried in memory of the smart card 122. For example, a patient's prescription can be carried securely on the smart card, as well as allergy information, emergency contact information, blood type, doctor, and donor rights information (i.e., background information about the user of the type that can be defined in the medical history data 54 of FIG. 3). Additional information that the user may readily need, and which may be needed in circumstances where a data connection to the database 26 is unavailable, can be stored as well, such as administrative information like electronic payments, electronic data interchange (EDI), electronic order processing, on-line data transfer, medical analysis, accounting by insurance carrier, insurance policy information such as, but not limited to, coverage and terms, medical images and lab reports. As such, in the embodiments shown, the various data is illustrated as equivalently stored either at the smart card 122 or the database 26 (illustrated by dual brackets referring to memory 126 and database 26.

In various embodiments, the data held in memory 126 of the smart card 122 or database 26 can be managed according to a variety of different formats. In one example embodiment, the smart card 122 is a Java-compatible card, capable of storing data in a manner accessible via one or more applications compatible with Java 3.0 standards or higher. In some embodiments, the memory 126 can store one or more Java-compatible applications which manage storage, retrieval, and possibly display of the data stored on the smart card 122. In one example embodiment, the smart card 122, and associated smart card reader 123, correspond to an AB-25SK smart kiosk and associated card provided by Arden Bourne LLC of Mico, Tex. The AB-25SK is a kiosk that is designed as a secure thin-client computing device featuring a color, back-lit, LCD touch screen interface and embedded smart card reader(s). The AB-25SK requires less than 5 volts of power that is delivered via Power-over-Ethernet (PoE). Other types of smart card and smart kiosk systems are available as well, and could equivalently be used. Additional details regarding example hardware useable in a smart card 122 and reader device 123 are discussed in U.S. Pat. No. 5,995,965.

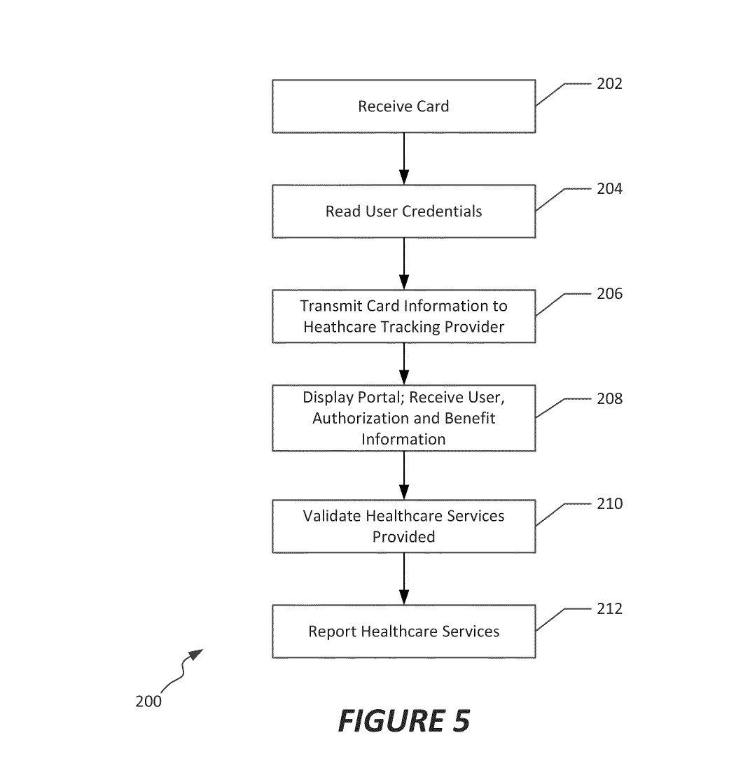

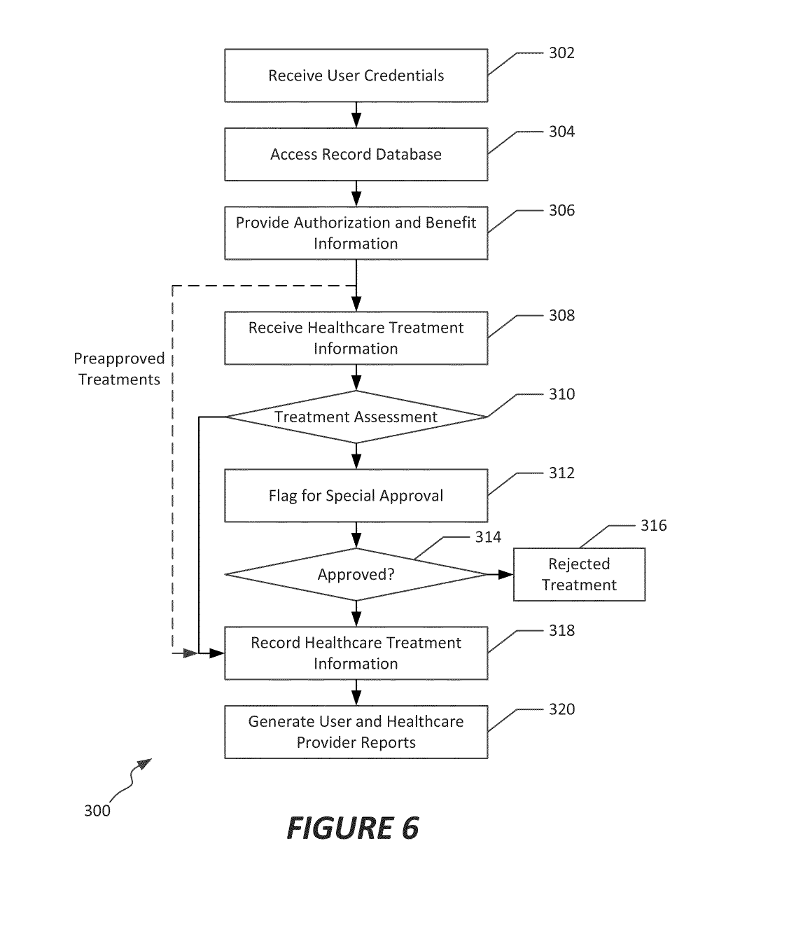

Referring now to FIGS. 5-6, flowcharts of methods and systems for use and operation of an account tracking system are disclosed, according to example embodiments of the present disclosure. The methods and systems disclosed herein can be implemented as operations, steps, or procedures running on a programmable circuit within a computer, or embodied in memory of a computer. FIG. 5 is a flowchart of an example method 500 for use of an account tracking system 10 at a location where a health resource encounter may take place, according to an example embodiment of the present disclosure. The method 500 is generally performed at a healthcare facility, such as a medical facility or pharmacy.

In the embodiment shown, the method 500 begins when a healthcare user 18 arrives at a location at which a health resource encounter may take place, such as a healthcare facility 16 as illustrated in FIG. 1. The method 500 includes receiving a portable device 22 (e.g., a smart card 122) associated with that user and capturing information stored on that device which identifies the user and/or describes that user's health history (step 202). The method also includes receiving input of user credentials from the user, such as a PIN or password input from the user, separate from the portable device 22, to validate that the user is in fact the correct individual associated with the card (step 204).

In some embodiments, the above-described reading and validation steps 202, 204 can include, for example, authenticating the user to the server 12, and logging an access attempt (irrespectively of whether the access attempt is ultimately successful) (step 206). In other words, when a user 18 attempts an access at a healthcare facility but is unsuccessful, the healthcare provider can deny service, and can input encounter information regarding the individual attempting access. That data can also be returned electronically to the central server. By logging each access attempt by a user, fraudulent access attempts can be tracked and lost or stolen cards can be deactivated as needed by the server 12, and within the healthcare database 26. Additional details regarding validation of user information, as well as initial activation of a smart card for use within the system 10, are described below in conjunction with FIG. 7.

Upon validation of a user at the server 12, a portal can be displayed to the healthcare provider (e.g., in this case a pharmacist or admissions department of a hospital or clinic), so that the healthcare provider can validate any additional details as needed, and view health benefit information (step 208). For example, the healthcare provider can be presented with a photograph of the user that is included within that user's record at the database 26, as well as any further information needed by that healthcare provider that may be incomplete within the user's records. The health benefit information can be displayed to the healthcare provider to view and validate the user's eligibility in a particular health benefit plan based on the data presented.

At this point, the healthcare provider 20 will typically proceed with a typical healthcare encounter, such as fulfilling a prescription or providing medical services to the healthcare user 18. Any such services can be entered into the portal displayed to the healthcare provider 20, for communication to the server 12 and database 26. As discussed further below in connection with FIG. 6, it may be the case that one or more services provided to a healthcare user 18 may require prior approval by that user's benefit provider. In such cases, the services entered into the portal and communicated to the server are validated, and approval is returned to the portal to indicate that the services can be performed within the scope of the benefit plan of that user (step 210).

For example, in the context of providing medical treatments to a healthcare user, a diagnosis would be entered into the portal by the healthcare provider, and additionally a proposed course of treatment would be included as well. The proposed treatment may be among a list of preapproved treatments, may be a treatment that can be approved in the particular user's case, or may require special approval from an insurer. In the first two cases, the healthcare provider will receive the approvals in step 210 and proceed to provide treatment. In the third case where special approval may be required, the healthcare provider and user may schedule a follow-on visit for providing treatment once approval of the treatment has been received from the health benefit provider (as entered into a benefit provider portal accessible on server 12).

For example, the healthcare provider can determine whether particular treatments are acceptable based on a membership of that user in a plan, as defined by the user and benefit information received in step 208. Upon valid authorization of a user and diagnosis of that user by a medical professional, the diagnosis can be entered into the web portal interface to the server 12 by the healthcare provider. A response can be returned to the healthcare provider via the portal to determine whether the service is approved, or needs special approval. Alternatively, an admissions department at a particular medical facility can enter a diagnosis and preapproved procedures that are performed on the user within a predetermined time of the user's visit to the clinic or hospital.

Once a treatment or a particular healthcare encounter is completed, the healthcare provider can return the user's device (e.g., smart card) to him or her if it has not previously been returned, and can complete entry of one or more resulting details of the health resource encounter (step 212). In the case of a pharmacy encounter, this can include a record of a fulfillment of a prescription, including updating a filled status of the prescription, indicating a time and date of the prescription being filled, as well as costs charged and other identifying information. In the case of a medical encounter, this can include entry of one or more treatments completed, a course of action taken, test results that have been obtained, or other health record information.

Referring now to the method 200 overall, it is apparent that the various steps described herein represent a general view of the process, and variations to this method may exist based on the specific type of health resource encounter and the specific health treatment to be applied. Additionally, in some cases, certain aspects of the method 200 may be performed in a different order, such as displaying of a portal to a healthcare user prior to validation of the user. Other variations in the above description and the method depicted in FIG. 5 are possible as well.

Referring now to FIG. 6, a flowchart of an example method 300 of operation of an account tracking system 10, according to an example embodiment of the present disclosure. The method 300 is generally embodied at or performed by a health resource encounter tracking server 12 and optionally a cloud provider 28, to provide and coordinate data associated with health resource encounters.

The method 300 includes receiving user credentials from a healthcare provider, which signifies the beginning of a health resource encounter (step 302). This generally occurs once the user has arrived at a healthcare provider and presented their smart card 122 or other device 22, and has provided authorization information. The health resource encounter tracking server 12 will then access one or more records in a healthcare database 26 associated with that user (step 304). The records can include identity of the user and the PIN or password received from the healthcare provider, to allow the server 12 to validate the user. Additionally, upon validation, the server 12 can obtain and transmit to the healthcare provider one or more records defining the healthcare user's health history (e.g., medical history or prescription history, allergies, etc.), and benefit plan information to allow the healthcare provider to view and validate the plan(s) and benefits associated with the user relative to services or items to be provided (step 306). For example, the server 12 can generate a portal page useable by a healthcare provider that includes data associated with a particular user, for use by the healthcare provider to enter additional information as needed regarding the user or regarding treatments to be provided. One embodiment of this portion of method 300 is further described below in connection with FIG. 7.

The method 300 generally continues when a healthcare provider enters additional information regarding a healthcare user, such as healthcare treatment information. The healthcare treatment information can be, for example, a proposed treatment following a diagnosis by the healthcare provider. This information is received at the portal presented to the healthcare provider and relayed to the server 12 (step 308). If the treatment is not acceptable to a health benefit plan administrator or lacks certain details to make approval impossible (as determined at treatment assessment operation 310) operation within the method 500 proceeds to flag the treatment for special approval by an individual at the plan administrator (step 312). This may result in the health benefit plan administrator contacting the healthcare provider for additional information regarding the proposed treatment to determine whether special approval should be granted. Once that assessment is performed and entered at the server 12 (step 314), the treatment is either rejected (step 316) or allowed to proceed. Alternatively, if the treatment is acceptable based on all currently available information, an authorization of the treatment is returned to the healthcare provider.

Once the healthcare provider receives authorization to provide treatment from the health plan administrator, that provider will proceed to provide health services to the healthcare user 18. The healthcare provider will the record data regarding the provided treatment into the portal for receipt at the server 12, and recording in the healthcare database 26 as part of the user records 50.

Additionally, in the case where one or more treatments are preapproved within a particular benefit plan, the server 12 will receive an indication from the healthcare provider once those treatments have been administered (at step 318). Preapproved treatments can include, in the context of a medical provider, preventative treatments, such as periodic checkups. In the case of a pharmacy encounter, nearly all treatments are considered “preapproved” treatments, since all treatments (i.e., fulfillment of a prescription) has been approved by a medical professional and the benefit provider has been notified at the time of the medical facility visit giving rise to the issuance of a new prescription.

Once healthcare treatment information has been received, the user's health resource encounter has generally been completed. Following the encounter, the user or healthcare provider, or third party, may wish to view one or more reports that include information recorded in a healthcare database 26 based on the user's health resource encounters (step 320). For example, the user 18 may wish to view a record of the history of his/her health resource encounters, or health benefit plan information. Alternatively, the healthcare provider may wish to review the records of the particular user or a group of users to determine administrative procedures for a particular benefit plan, or efficacy of a particular treatment, or cost information relating to collection of payment from the benefit plan provider and/or user. In still other examples, a third party, such as a governmental organization, may wish to view aggregated report data regarding treatments within a particular plan, of a particular user, or administered by a particular healthcare facility or facilities. Each of these types of information can be acquired via access of the server 12 by an authorized member of each type of entity (e.g., a user having access to his or her own data, or a healthcare provider having access to records of encounters at that provider's facility, or a benefit plan administrator monitoring users and/or facilities participating in a particular plan).

Referring now to the method 300 overall, it is apparent that the various steps described herein represent a general view of the process, and variations to this method may exist based on the specific type of health resource encounter and the specific health treatment to be applied. Additionally, in some cases, certain aspects of the method 300 may be performed in a different order, analogously to (and complementarily to) changed order of operations in the method 200 of FIG. 5. Other variations in the above description and the method depicted in FIG. 6 are possible as well.

Referring now to FIG. 7, a flowchart of a method 400 of validating a user and providing a user interface for interaction with an online portal of the account tracking system is disclosed, according to an example embodiment of the present disclosure. The method 400 generally illustrates a general process for associating a healthcare user 18 with a device 22, such as a smart card 122, for use within the system 10. Generally, the method 400 illustrates actions taken by a user 18, such as a member of a particular benefit plan (referenced as “User”), as well as a healthcare provider 16 (referenced as “Provider”), a device 22 and associated reader 24 and computing system 25 (collectively referenced as “Card/Reader”), and a health resource encounter tracking server 12 and portal 13 associated therewith (referenced as “Portal”).

In the embodiment shown, the method 400 begins with distributing a device to a user, with whom the device is to be associated (step 402). At a time where the user wishes to initiate a health resource encounter, he/she will visit a healthcare facility and provide the device to a reader (step 404). In the case of a smart card device such as smart card 122, the card can be inserted into a reader 123, as previously described. In various implementations, the user or a healthcare provider can insert the card into a reader.

Continuing to discuss the method 400 within the context of a smart card system, if the smart card has not yet been activated, the card is recognized by the reader as lacking associated user information stored thereon (step 406). The card will be assigned an identification number (e.g., which is optionally generated at, but also at least registered at the health resource encounter tracking server 12), thereby assigning a unique number to the user of the card to be used for future card access (step 408). The reader will also load a hop code onto the smart card (step 410), which allows the smart card to be authenticated by the health resource encounter tracking server 12 as associated with the server 12 and known within the healthcare database 26 (step 412).

A validation operation (step 414) assesses the hop code and determines whether the card is intended for use with the health resource encounter tracking server 12. If the hop code is not valid, the health resource encounter tracking server 12 will return an error, which will be displayed at the reader (step 416). The healthcare provider will then retain the card, either due to its malfunctioning or due to an attempted fraudulent access (step 418). This therefore completes the health resource encounter (terminating at step 420).

However, if the hop code is validated successfully in step 414, the server rolls its stored hop code to a next subsequent hop code (step 422), and the hop code of the card is rolled to a subsequent hop code as well via the reader (step 424). The user is presented with a prompt to receive user credentials, such as a username and/or password, or PIN number (step 426). The healthcare provider can enter the credentials of the user, or the user can do so at this time (step 428). The credentials are submitted at the reader (step 430), which then locally authenticates the user (step 432). A remote authentication process also authenticates the user remotely, and if the user is a new user, stores the assigned credentials within the healthcare database 26 (step 434). If the user credentials are incorrect (as determined by validation step 436), an error is displayed on the reader indicating that the credentials entered were incorrect (step 438). Operation returns to step 428 to allow the user to re-enter user credentials for one or more additional times, until an optional lockout occurs (not shown).

If the entered credentials are validated at the reader and portal successfully, a user interface is then generated by the health resource encounter tracking server 12, and transmitted back to the reader or other computing system provided at the healthcare provider (step 440). The reader or other computing system then renders the web-based portal content (step 442), which can be viewed by the healthcare provider. The portal content can include, for example, information regarding the user associated with the smart card, and health benefit plan information, as discussed above. From this point, operation proceeds as discussed above in connection with FIGS. 5-6.

Referring to FIG. 7 generally, it is recognized that the method 400 as illustrated presents each of the steps typically required in a first-time use and registration of a smart card or other analogous device. It is noted that, in subsequent encounters, variations may occur in the overall method. For example, it will at least not be necessary for the user to receive a new card (step 402), or to have his or her member identification and/or hop codes re-loaded onto the card (steps 408, 410). Other variations may occur as well.

Referring now to FIG. 8, a flowchart of a method 450 of validating a user and providing a user interface for interaction with an online portal of the account tracking system is disclosed, according to a further example embodiment of the present disclosure. As compared to the embodiment discussed above with respect to FIG. 7, the method 450 is generally performed in the case where only a user's identification information is stored on a device 22 (e.g., smart card 122), such as discussed above in connection with FIG. 4. In such a case, certain steps of FIG. 7 are obviated, since data storage and transmission of data between the smart card and health resource encounter tracking server 12 becomes unnecessary.

In the embodiment shown, the method 450 begins with distributing a device to a user, with whom the device is to be associated (step 402). At a time where the user wishes to initiate a health resource encounter, he/she will visit a healthcare facility and provide the device to a reader (step 404). If the smart card has not yet been activated, the card is recognized by the reader as lacking associated user information stored thereon, and will assign an identification number to the card, thereby assigning a unique number to the user of the card to be used for future card access (step 456). The card identifier is then read (step 458), and the user and healthcare provider are redirected to a portal (e.g., portal 13) for accessing the user's health records.

At the portal, a prompt for credentials is presented (step 426) and credentials are entered (step 428). The user is authenticated at the portal (step 434); if the credentials are incorrect (as determined by validation step 436), an error is displayed on the reader indicating that the credentials entered were incorrect (step 438). Otherwise the healthcare provider is allowed to view content associated with the user (step 444), for example via a web interface. However, if the user is no longer enrolled in a benefit program associated with the card, the provider may elect to retain the card (step 418) or may otherwise simply indicate that no current benefits are associated with that particular user (as would be tracked in the database 26).

In both methods 400, 450, once the user is approved, a healthcare provider can perform any of a number of operations based on that user's information. For example, the healthcare provider can view/update contact information of the user, and can access that user's benefit information. This may include, in some embodiments, accessing a claims processing tool or claims price estimator tool, which would allow the healthcare provider to view an approved coverage limit or cost recovery for various treatments or medications, or obtain preapproval for specific treatments. Additionally, even once the customer visit is complete, it is noted that in some embodiments, the healthcare provider can access the portal to view past visits of users, and to track progress of payments from one or more benefit programs associated with those users. Other operations may be made available to the healthcare providers and/or users as well outside the context of a healthcare encounter, such as allowing the user and/or provider to access that user or entity's identifying information, benefit elections, payment/reimbursement options, or other features.

Referring to FIGS. 1-8 generally, it is recognized that the systems and methods of the present application present a number of advantages over preexisting smart card health benefit systems. For example, the present disclosure contemplates greater involvement from a health benefit provider by providing a portal in which diagnoses and suggested treatments can be reviewed and preapproved, thereby guaranteeing payment from the benefit provider to the healthcare facility. Additionally, the present disclosure contemplates integration with disparate types of unaffiliated healthcare providers, and logs records associated with a variety of types of healthcare encounters, including those in which no treatment is provided. Furthermore, the systems and methods described herein are capable of being used with multiple benefit providers, including separate private benefit providers for different users, or drawing from multiple benefit programs (both private and government-sponsored) for a single user. Other advantages are apparent as well from the present disclosure.

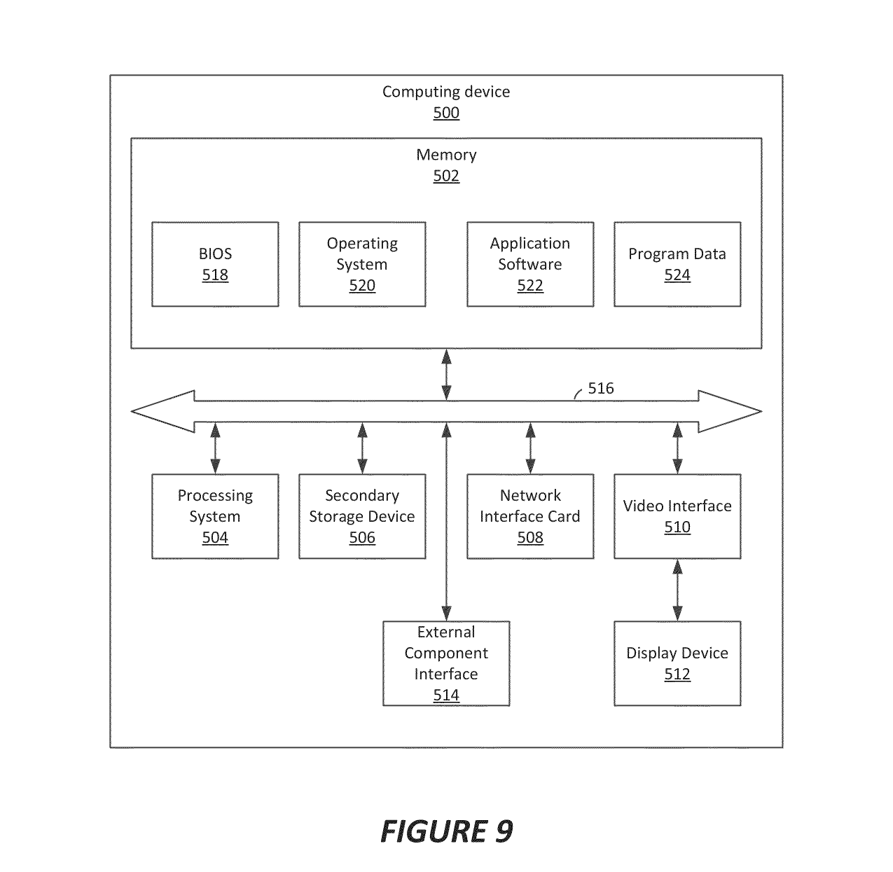

Referring now to FIG. 9, a block diagram illustrating an example computing device 500 is shown, which can be used to implement aspects of the present disclosure. In particular, the computing device 500 can represent a server, such as server 12 of FIG. 1, or any of the computing devices used by the user 18 or healthcare provider 20 at the healthcare facility 16 or in a home environment (in the case of user 18). The computing device 500 can be used to execute any of the methods or implement any of the systems discussed herein.

In the example of FIG. 9, the computing device 500 includes a memory 502, a processing system 504, a secondary storage device 506, a network interface card 508, a video interface 510, a display unit 512, an external component interface 514, and a communication medium 516. The memory 502 includes one or more computer storage media capable of storing data and/or instructions. In different embodiments, the memory 502 is implemented in different ways. For example, the memory 502 can be implemented using various types of computer storage media.

The processing system 504 includes one or more processing units. A processing unit is a physical device or article of manufacture comprising one or more integrated circuits that selectively execute software instructions. In various embodiments, the processing system 504 is implemented in various ways. For example, the processing system 504 can be implemented as one or more processing cores. In another example, the processing system 504 can include one or more separate microprocessors. In yet another example embodiment, the processing system 504 can include an application-specific integrated circuit (ASIC) that provides specific functionality. In yet another example, the processing system 504 provides specific functionality by using an ASIC and by executing computer-executable instructions.

The secondary storage device 506 includes one or more computer storage media. The secondary storage device 506 stores data and software instructions not directly accessible by the processing system 504. In other words, the processing system 504 performs an I/O operation to retrieve data and/or software instructions from the secondary storage device 506. In various embodiments, the secondary storage device 506 includes various types of computer storage media. For example, the secondary storage device 506 can include one or more magnetic disks, magnetic tape drives, optical discs, solid state memory devices, and/or other types of computer storage media.

The network interface card 508 enables the computing device 500 to send data to and receive data from a communication network. In different embodiments, the network interface card 508 is implemented in different ways. For example, the network interface card 508 can be implemented as an Ethernet interface, a token-ring network interface, a fiber optic network interface, a wireless network interface (e.g., Wi-Fi, WiMax, etc.), or another type of network interface.

The video interface 510 enables the computing device 500 to output video information to the display unit 512. The display unit 512 can be various types of devices for displaying video information, such as a cathode-ray tube display, an LCD display panel, a plasma screen display panel, a touch-sensitive display panel, an LED screen, or a projector. The video interface 510 can communicate with the display unit 512 in various ways, such as via a Universal Serial Bus (USB) connector, a VGA connector, a digital visual interface (DVI) connector, an S-Video connector, a High-Definition Multimedia Interface (HDMI) interface, or a DisplayPort connector.

The external component interface 514 enables the computing device 500 to communicate with external devices. For example, the external component interface 514 can be a USB interface, a FireWire interface, a serial port interface, a parallel port interface, a PS/2 interface, and/or another type of interface that enables the computing device 500 to communicate with external devices. In various embodiments, the external component interface 514 enables the computing device 500 to communicate with various external components, such as external storage devices, input devices, speakers, modems, media player docks, other computing devices, scanners, digital cameras, and fingerprint readers.

The communications medium 516 facilitates communication among the hardware components of the computing device 500. In the example of FIG. 9, the communications medium 516 facilitates communication among the memory 502, the processing system 504, the secondary storage device 506, the network interface card 508, the video interface 510, and the external component interface 514. The communications medium 516 can be implemented in various ways. For example, the communications medium 516 can include a PCI bus, a PCI Express bus, an accelerated graphics port (AGP) bus, a serial Advanced Technology Attachment (ATA) interconnect, a parallel ATA interconnect, a Fiber Channel interconnect, a USB bus, a Small Computing system Interface (SCSI) interface, or another type of communications medium.

The memory 502 stores various types of data and/or software instructions. For instance, in the example of FIG. 9, the memory 502 stores a Basic Input/Output System (BIOS) 518 and an operating system 520. The BIOS 518 includes a set of computer-executable instructions that, when executed by the processing system 504, cause the computing device 500 to boot up. The operating system 520 includes a set of computer-executable instructions that, when executed by the processing system 504, cause the computing device 500 to provide an operating system that coordinates the activities and sharing of resources of the computing device 500. Furthermore, the memory 502 stores application software 522. The application software 522 includes computer-executable instructions, that when executed by the processing system 504, cause the computing device 500 to provide one or more applications. The memory 502 also stores program data 524. The program data 524 is data used by programs that execute on the computing device 500.

Although particular features are discussed herein as included within an electronic computing device 500, it is recognized that in certain embodiments not all such components or features may be included within a computing device executing according to the methods and systems of the present disclosure. Furthermore, different types of hardware and/or software systems could be incorporated into such an electronic computing device.

In accordance with the present disclosure, the term computer readable media as used herein may include computer storage media and communication media. As used in this document, a computer storage medium is a device or article of manufacture that stores data and/or computer-executable instructions. Computer storage media may include volatile and nonvolatile, removable and non-removable devices or articles of manufacture implemented in any method or technology for storage of information, such as computer readable instructions, data structures, program modules, or other data. By way of example, and not limitation, computer storage media may include dynamic random access memory (DRAM), double data rate synchronous dynamic random access memory (DDR SDRAM), reduced latency DRAM, DDR2 SDRAM, DDR3 SDRAM, DDR4 SDRAM, solid state memory, read-only memory (ROM), electrically-erasable programmable ROM, optical discs (e.g., CD-ROMs, DVDs, etc.), magnetic disks (e.g., hard disks, floppy disks, etc.), magnetic tapes, and other types of devices and/or articles of manufacture that store data. Computer storage media generally excludes transitory wired or wireless signals. Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

The above specification, examples and data provide a complete description of the manufacture and use of the composition of the invention. Since many embodiments of the invention can be made without departing from the spirit and scope of the invention, the invention resides in the claims hereinafter appended.

1. A system for tracking accounts associated with health resource encounters, the system comprising:
a plurality of portable identification devices, each of the portable identification devices associated with a user and a benefit account, the user comprising a healthcare consumer and the benefit account defining coverage available to the user, each of the plurality of portable identification devices including a memory configured to store identification data of a user with whom the portable identification device is associated;
a plurality of computing devices each affiliated with a health resource provider at which a health resource encounter takes place, each of the plurality of computing devices configured to:
prior to each health resource encounter between a user and the health resource provider, receive information from a portable identification device associated with the user from among the plurality of portable identification devices,
receive validation information from the user;
transmit the validation information to a heath resource encounter tracking server;
receive authorization information and benefit information associated with the user from the health resource encounter tracking server;
record a log of the health resource encounter; and
transmit the log of the health resource encounter to the heath resource encounter tracking server; and
a health resource encounter tracking server remotely connected to each of the plurality of computing devices via a network, the health resource encounter tracking server configured to access a healthcare information database including data affiliated with a plurality of users, a plurality of benefit providers, and a plurality of heath resource providers, the health resource providers including at least medical providers and pharmacy providers.

2. The system of claim 1, wherein the plurality of portable identification devices comprises one or more smart cards.

3. The system of claim 2, wherein each of the computing devices includes a smart card reader.

4. The system of claim 2, wherein each of the one or more smart cards includes a programmable circuit and a memory, and wherein the memory is configured to store at least an identifier of the user associated with the smart card.

5. The system of claim 4, wherein the memory is further configured to store insurance benefit information and medical records of the user.

6. The system of claim 1, wherein the health resource providers are selected from a list of providers consisting of:
medical providers;
pharmacy providers;
dental providers;
vision care providers;
chiropractors; and
clinical services providers.

7. The system of claim 1, wherein the health resource encounter tracking server is configured to integrate records from one or more governmental health organizations.

8. The system of claim 1, wherein each of the plurality of computing devices is configured to record a log of each attempted health resource encounter.

9. The system of claim 1, wherein the data affiliated with a plurality of users stored in the healthcare information database includes user data selected from the group consisting of:
authentication data;
medical history data;
pharmacy data;
eligibility information;
cost sharing or apportionment data;
authorization requests; and
program benefit data.

10. The system of claim 1, wherein the data affiliated with the plurality of health resource providers includes provider data selected from the group consisting of:
entity information;
authorized services;
prescription information;
healthcare provider service records;
claim processing tools;
claim price estimation tools; and
cost records.

11. The system of claim 1, wherein the data affiliated with the plurality of benefit providers includes benefit data selected from the group consisting of:
associated medical provider identifications;
associated pharmacy provider identifications; and
benefit program definitions.

12. The system of claim 1, wherein the healthcare information database further includes third party program information.

13. The system of claim 1, wherein the health resource encounter tracking server is further configured to exchange healthcare information regarding one or more of the plurality of users with a third party system.

14. The system of claim 1, wherein the health resource encounter tracking server is configured to provide to a user, in response to a request from a remote computing system, one or more reports regarding health resource encounters associated with that user.

15. The system of claim 1, wherein the health resource encounter tracking server is configured to provide, in response to a request from a remote computing system, one or more aggregated reports regarding health resource encounters associated with a plurality of users.

16. The system of claim 15, wherein the one or more aggregated reports are provided in response to a request from a health resource provider.

17. The system of claim 15, wherein the one or more aggregated reports are provided in response to a request from a benefit provider.

18. A method of managing healthcare users affiliated with a plurality of different, unaffiliated healthcare resource providers, the method comprising:
prior to a health resource encounter between a user and a health resource provider, receiving, at a heath resource encounter tracking server, information from a computing device affiliated with the health resource provider, the information including data stored on a portable identification device associated with a user, validation information entered by the user, and an identity of the health resource provider;
based on the data stored on the portable identification device, the validation information, and the identity of the health resource provider, determining a set of benefit information based on data stored in a healthcare information database, the healthcare information database including data affiliated with a plurality of users, a plurality of benefit providers, and a plurality of heath resource providers, the health resource providers including at least medical providers and pharmacy providers;
receiving, at the heath resource encounter tracking server, a log of the health resource encounter; and
storing the log of the health resource encounter in the healthcare information database.

19. The method of claim 18, wherein the log of the health resource encounter comprises an access attempt in which the validation information entered by the user does not correspond with the data stored on the portable identification device, thereby indicating an unauthorized access attempt.

20. The method of claim 18, wherein the health resource encounter comprises a medical resource encounter.

21. The method of claim 20, wherein the log of the medical resource encounter includes one or more preapproved treatments associated with a medical resource provider.

22. The method of claim 18, further comprising:
receiving, at the health resource encounter tracking server, an indication of a proposed healthcare treatment; and
based at least in part on the proposed healthcare treatment and the benefit information, transmitting an approval of the proposed healthcare treatment to the computing device.

23. The method of claim 18, further comprising generating one or more reports in response to a user request.

24. A system for tracking accounts associated with health resource encounters, the system comprising:
a plurality of smart cards, each of the smart cards associated with a user and a benefit account defining coverage available to the user, each of smart cards including a programmable circuit and a memory configured to store identification data of a user with whom the smart card is associated; and
a plurality of computing devices each affiliated with a health resource provider at which a health resource encounter takes place, each of the plurality of computing devices configured to:
prior to each health resource encounter between a user and the health resource provider, read information from a smart card associated with the user from among the plurality of smart cards,
receive validation information from the smart card;
transmit the validation information and information from the smart card to a heath resource encounter tracking server;
receive authorization information and benefit information associated with the user from the health resource encounter tracking server;
record a log of the health resource encounter; and
transmit the log of the health resource encounter to the heath resource encounter tracking server; and
a health resource encounter tracking server remotely connected to each of the plurality of computing devices via a network, the health resource encounter tracking server configured to access a healthcare information database including data affiliated with a plurality of users, a plurality of benefit providers, and a plurality of health resource providers, the health resource providers including at least medical providers and pharmacy providers,
wherein the health resource encounter tracking server is further configured to:
generate one or more reports in response to requests from remote computing systems; and
exchange healthcare information regarding one or more of the plurality of users with a third party system, the healthcare information including the one or more reports.
